(19) United States
(12) Patent Application Publication
(10) Pub. No.: US 2007/0243854 A1
(43) Pub. Date: Oct. 18, 2007

(54) Information Processing Apparatus, Vehicle Control System and Information Processing Method

(75) Inventors: Naoki Taki, Aichi (JP); Atsushi Watanabe, Aichi (JP); Mayumi Otsuka, Aichi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/628,944

(22) PCT Filed: Dec. 14, 2005
(86) PCT No.: PCT/JP05/23431

§ 371 Date: Dec. 8, 2006

(30) Foreign Application Priority Data
Jan. 11, 2005 (JP) 2005-004371

(51) Int. Cl. H04M 11/04

(52) U.S. Cl. 455/404.1

(57) ABSTRACT

A physical condition of a vehicle occupant is monitored; the vehicle occupant's physical condition information is transmitted to the center by the vehicle when an urgent message is transmitted to the center; and the center determines whether or not an urgent message is to be transmitted to a predetermined urgent message destination, based on the vehicle occupant's physical condition information.

### TECHNICAL FIELD

The present invention relates to an information processing apparatus, a vehicle control system and an information processing method, and, in particular, to an information processing apparatus and a vehicle control system configuring an urgent message system, and an information processing method executed in the urgent message system, which urgent message system is suitable for effectively transmitting a message to a predetermined message destination from a vehicle via a center.

### BACKGROUND ART

In the prior art, an urgent message system is known (see Japanese Patent No. 3331937, for example) in which an urgent message to an urgent message destination from a vehicle via a center is generated when the necessity arises. In this system, urgent message destinations such as the police, the fire fighting and so forth, to which an urgent message may be transmitted via the center, are previously registered in the vehicle. Then, when the necessity arises, an urgent message is transmitted to the previously registered urgent message destination via the center.

In this system, in which an urgent message to the urgent message destination from the vehicle via the center is generated unconditionally upon occurrence of the necessity. Accordingly, an erroneous urgent message may be transmitted to the urgent message destination due to an erroneous operation of an operation switch or such. In order to eliminate such a problem, such a system has been put into a practical use that, when an urgent message is transmitted to the center from the vehicle, the vehicle occupant and an operator in the center verbally communicate with one another. Then, from a result of the verbal communication, the center operator determines a situation of the vehicle and the vehicle occupant, and then, manually sends an urgent message to the urgent message destination if necessary, on behalf of the vehicle occupant.

### DISCLOSURE OF THE INVENTION

However, in this system, for a case where the vehicle occupant suddenly has a serious problem in his or her physical condition such as a sudden illness, or a car accident has occurred, and thus, the vehicle occupant cannot voluntarily make a verbal communication with the center operator, the center operator cannot grasp the situation of the vehicle or the vehicle occupant. As a result, an urgent message may not be transmitted properly, and thus, appropriate measures may not be carried out.

The present invention has been devised in consideration of the above-mentioned problem, and an object of the present invention is to provide an urgent message system according to a first aspect of the present invention by which, even when a vehicle occupant is in such a situation that he or she cannot verbally communicate with a center operator after an urgent message is transmitted to the center from the vehicle, the center can appropriately generate an urgent message to the urgent message destination.

The above-mentioned object of the present invention is achieved by an urgent message system, according to a first aspect of the present invention, for transmitting an urgent message to a predetermined urgent message destination from a center if necessary when receiving an urgent message from a vehicle, including: a physical condition monitoring part monitoring a physical condition of a vehicle occupant; a transmitting part transmitting the vehicle occupant's physical condition information to the center from the vehicle when an urgent message is transmitted to the center; and a determining part determining whether or not an urgent message is to be transmitted to the predetermined urgent message destination, based on the vehicle occupant's physical condition information transmitted from the vehicle.

In this configuration, when an urgent message is transmitted from the vehicle to the center, the vehicle transmits a physical condition of an occupant of the vehicle. Then, the center determines whether or not an urgent message should be actually transmitted to the predetermined urgent message destination, based on the vehicle occupant's physical condition thus transmitted from the vehicle. Accordingly, even when the vehicle occupant cannot make verbal communication with the center operator due to a sudden illness of the vehicle occupant or such after the transmission of the urgent message from the vehicle to the center, the center transmits an urgent message to the urgent message destination if necessary according to the physical condition of the vehicle occupant thus transmitted from the vehicle. Thus, according to the present invention, an urgent message can be appropriately transmitted to the urgent message destination even when the vehicle occupant has a sudden illness or such.

According to a second aspect of the present invention, in the above-mentioned urgent message system in the first aspect of the present invention, the transmitting part may transmit vehicle interior image information taken by a camera provided for taking a situation of the vehicle interior to the center from the vehicle when an urgent message is transmitted to the center; and the determining part may determine whether or not an urgent message is to be transmitted to the predetermined urgent message destination, based on the vehicle interior image information transmitted by the center.

Thereby, even when the vehicle occupant has a sudden illness or such and cannot verbally communicate with the center operator by himself or herself, an urgent message may be transmitted from the center to the urgent message destination according to the vehicle interior image transmitted from the vehicle. Accordingly, an urgent message can be appropriately transmitted to the urgent message destination even when the vehicle occupant has a physical condition problem, for example.

In the case of the above-mentioned first or the second aspect or the present invention, as in a third aspect of the present invention, the center may select the predetermined urgent message destination based on the vehicle occupant's physical condition information or the vehicle interior image information transmitted by the vehicle.

Thereby, appropriate one of the predetermined urgent message destinations can be applied, for example, the fire fighting is selected when the vehicle occupant has a sudden illness, the police is selected when a quarrel occurs between the vehicle occupant and an intruder, or such, which situation can be recognized from the vehicle occupant's physical condition information or the vehicle interior image information transmitted by the vehicle. Thus, appropriate urgent message transmission can be carried out.

Further, the above-mentioned object of the present invention may also be achieved by an urgent message system according to a fourth aspect of the present invention of transmitting an urgent message to a predetermined urgent message destination from a center if necessary when the center receives an urgent message from a vehicle, which system includes a physical condition monitoring part monitoring a physical condition of a vehicle occupant; a transmitting part transmitting the vehicle occupant's physical condition information to the center from the vehicle when an urgent message is transmitted to the center; and the center showing, to an operator, the vehicle occupant's physical condition information transmitted by the vehicle, for allowing the operator to determine whether or not an urgent message is to be transmitted to the predetermined urgent message destination.

In this configuration, from the vehicle, the vehicle occupant's physical condition information is transmitted to the center. Then, the center shows the vehicle occupant's physical condition information to the operator to allow the operator to appropriately determine whether or not an urgent message is to be actually transmitted to the present invention urgent message destination. The center operator can grasp the vehicle occupant's physical condition even when the center operator cannot actually verbally communicate with the vehicle occupant. Thus, the center operator can appropriately determine whether or not an urgent message is to be transmitted to the urgent message destination. Thus, according to the present invention, an urgent message can be appropriately transmitted to the urgent message destination even when the vehicle occupant has a sudden illness, for example.

In a fifth aspect of the present invention, according to the urgent message system according to the fourth aspect of the present invention, the transmitting part may transmit vehicle interior image information taken by a camera provided for taking a situation of the vehicle interior to the center from the vehicle when an urgent message is transmitted to the center; and the center may show the operator the vehicle interior image information transmitted by the vehicle for allowing the operator to determine whether or not an urgent message is to be transmitted to the predetermined urgent message destination.

In this configuration, the center operator can see the vehicle interior image information transmitted from the vehicle, even when the center operator cannot actually verbally communicate with the vehicle occupant. Then, the center operator can appropriately determine whether or not an urgent message is to be transmitted to the urgent message destination. Thus, according to the present invention, an urgent message can be appropriately transmitted to the urgent message destination even when the vehicle occupant has a sudden illness for example.

In a sixth aspect of the present invention, in the urgent message system according to any one of the first through fifth aspects of the present invention, the center may transfer, upon transmitting an urgent message to the predetermined urgent message destination, the vehicle occupant's physical condition information received from the vehicle to the predetermined urgent message destination.

In this configuration, the vehicle occupant's physical condition information itself is thus provided to the urgent message destination. Thereby, appropriate and prompt measures can be taken by the urgent message destination for the physical condition problem the vehicle occupant has.

In a seventh aspect of the present invention, in the urgent message system according to any one of the first through sixth aspects of the present invention, the center may request the vehicle to carry out a vehicle interior environment remote operation for improving a vehicle interior environment, when the center receives the vehicle occupant's physical information from the vehicle; and the vehicle may carry out the vehicle interior environment remote operation according to the request from the center.

In this configuration, the vehicle interior environment improves, and thus, the vehicle occupant, when having a physical condition problem, can improve in his or her physical condition.

In an eighth aspect of the present invention, in the urgent message system according to any one of the first through seventh aspects of the present invention, the center may request the vehicle to carry out an attention attracting remote operation for attracting attention from the vehicle surroundings, when the center receives the vehicle occupant's physical information from the vehicle; and the vehicle may carry out the attention attracting remote operation according to the request from the center.

The above-mentioned attention attracting operation may include, for example, operation of blinking a hazard lamp of the vehicle, lamp passing operation, operation of blowing an electric horn, or such. In this configuration, such an attention attracting operation is carried out for the surroundings of the vehicle remotely, without requiring any actual operation by the vehicle occupant. As a result, safety for the surroundings of the vehicle can be ensured, and also, those who are in the surroundings of the vehicle may easily find out the vehicle in which the occupant has a physical condition problem.

In a ninth aspect of the present invention, in the urgent message system according to any one of the first through eighth aspects of the present invention, the center may request the vehicle to carry out a running remote operation for bringing the vehicle into a stop or reducing the speed, when the center receives the vehicle occupant's physical information from the vehicle; and the vehicle may actually carry out the running remote operation according to the request of the center.

In this configuration, the vehicle is remotely brought into a stop or reduced in the speed, after the vehicle occupant has a physical condition problem. As a result, the safety for the surroundings of the vehicle can be ensured even when the vehicle occupant himself of herself cannot properly operate the vehicle.

In a tenth aspect of the present invention, in the urgent message system according to any one of the seventh through ninth aspects of the present invention, the center may request the vehicle to carry out the vehicle interior environment remote operation when transmitting the urgent message to the predetermined urgent message destination after receiving the vehicle occupant's physical condition information.

In an eleventh aspect of the present invention, in the urgent message system according to any one of the first through tenth aspects of the present invention, the vehicle may transmit an urgent message to the center when the vehicle occupant's physical condition detected in the physical condition motoring part deviates from a normal value.

In this configuration, the vehicle automatically transmits an urgent message to the center when the physical condition of the vehicle occupant becomes worse.

Thus, according to any one of the first through eleventh aspects of the present invention, the center can appropriately transmit an urgent message to the urgent message destination even when the vehicle occupant cannot make a verbal communication with the center operator by himself of herself due to a sudden illness or such after the center has an urgent message transmitted from the vehicle.

### BRIEF DESCRIPTION OF DRAWINGS

Other objects and further features of the present invention will become more apparent from the following detailed description when read in conjunction with the accompanying drawings:

FIG. 1 shows a general configuration diagram of an urgent message system in one embodiment of the present invention;

FIG. 2 shows operation of an on-vehicle unit in the urgent message system in the embodiment of the present invention;

FIG. 3 shows a flow chart of a main routine executed by the on-vehicle unit in the urgent message system in the embodiment of the present invention;

FIG. 4 shows a flow chart of operation carried out by the urgent message system in the embodiment of the present invention;

FIG. 5 shows one example of a configuration of a help net operation center in the urgent message system according to the embodiment of the present invention; and

FIG. 6 shows one example of a configuration of the on-vehicle unit in the urgent message system according to the embodiment of the present invention.

### BEST MODE FOR CARRYING OUT THE INVENTION

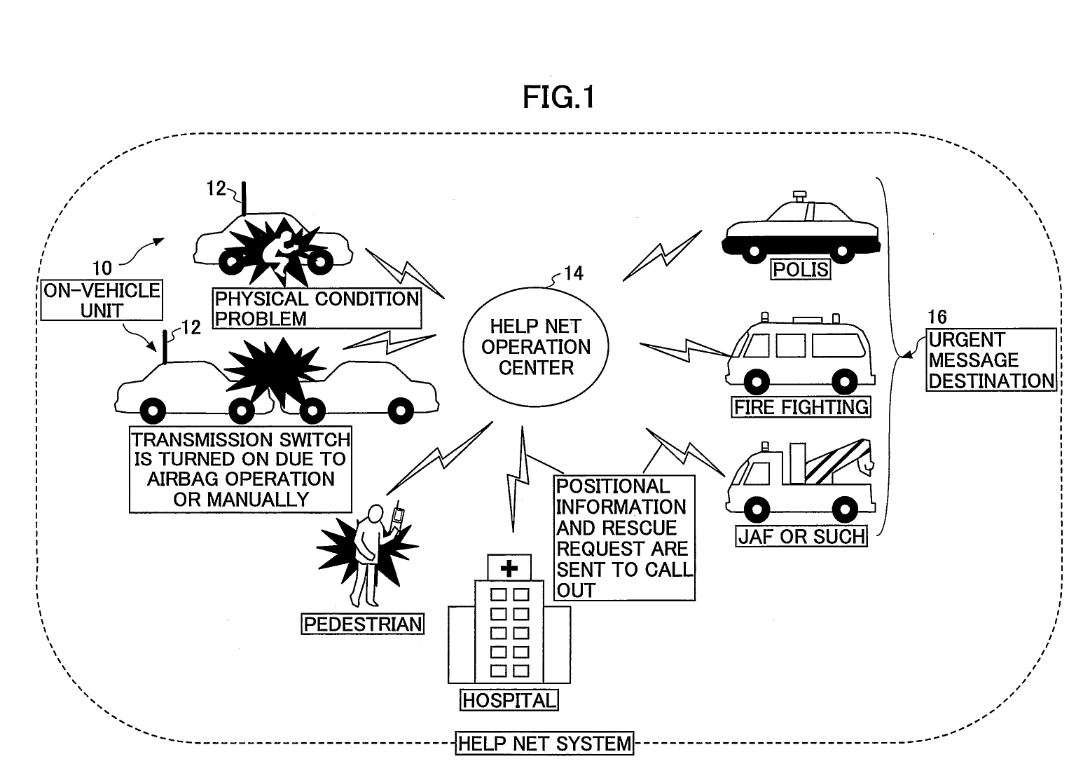

FIG. 1 shows a general configuration of an urgent message system in one embodiment of the present invention. The urgent message system includes an on-vehicle unit 10 mounted in a vehicle, a portable terminal device 12 such as a cellular phone held by a person, for example, a registered user such as a vehicle occupant or a vehicle owner, a help net operation center 14 (simply referred to as a ‘center’, hereinafter) receiving an urgent message from the potable terminal device 12, and urgent message destinations 16 receiving urgent messages from the center 14 and coping with corresponding urgent situations, such as the police, the fire fighting (fire station), a JAF or such. The urgent message system in the present embodiment is a system such that, when an urgent message is transmitted from the vehicle, i.e., the on-vehicle unit 10 connected with the portable terminal device 12 to the center 14 via the portable terminal device 12, the center 14 transmits an urgent message to an appropriate one(s) of the urgent message destination 16 appropriately.

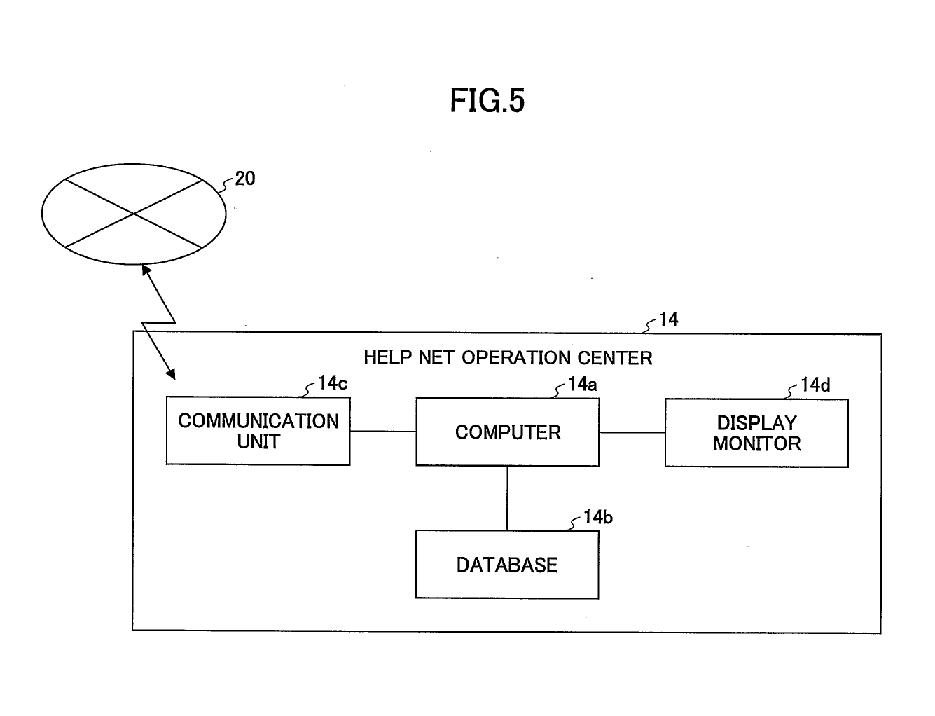

As shown in FIG. 5, the on-vehicle unit 10, acting as a vehicle control system, includes a master electronic control unit (simply referred to as a master ECU, hereinafter) 10a including a computer as a main body thereof. This master ECU 10a is connected to a GPS receiver 13. The master ECU 10a detects an absolute position of the vehicle based on radio waves received by the GPS receiver 13.

The master ECU 10a is connected with sensors 4, a camera 5 and so forth for measuring a physical condition of a vehicle occupant, in particular, a driver. The sensors 4 and so forth may be those for measuring a body temperature, a blood pressure, pulsation, brain wave, pupil dilation, and so forth, of the vehicle occupant. The master ECU 10a detects the body temperature, blood pressure, pulsation, brain wave, pupil dilation and so forth of the vehicle occupant based on the output signals of the sensors 4 and so forth connected thereto as mentioned above.

For the purpose of measuring a body temperature, a blood pressure, pulsation and so forth of the vehicle occupant as mentioned above, the following method may be actually applied, for example: That is, a sensor(s), as the sensor 4, is provided on a steering wheel of the vehicle, for measuring a body temperature, pulsation, a blood pressure and so forth of the driver via his or her hands, for example; a special sensor (as the sensor 5), in a wired or wireless type, for measuring a body temperature, pulsation, a blood pressure and so forth, is fitted to the body of the vehicle occupant, that is, for example, the vehicle occupant wears a wristwatch type body temperature, pulsation and blood pressure measuring device; or a thermography technology is applied for measuring a body temperature of the vehicle occupant with the use of the camera 5 or such.

The master ECU 10a has a storage device (memory or such) built therein for previously storing a normal value of the physical condition of the vehicle occupant. The normal value stored in the storage device may be preferably changeable by an input operation into that according to characteristics of each particular occupant who actually rides in or drives the vehicle. The master ECU 10a determines, as mentioned above, whether or not the detected physical condition of the vehicle occupant goes beyond the normal value, that is, whether or not the physical condition of the vehicle occupant becomes worse than a predetermined threshold.

The on-vehicle unit 10 can be connected to the portable terminal device 12 as mentioned above, the portable terminal device 12 acting as a communication device for the on-vehicle unit 10. Thereby, the on-vehicle unit 10 has a function of transmitting various sorts of information of the vehicle to the center 14 via a communication network 20 with the use of the portable terminal device 12. Also, the on-vehicle unit 10 has a function of receiving information transmitted by the center 14 via the communication network 20 with the use of the portable terminal device 12. Also, the on-vehicle unit 10 thus connected with the portable terminal device 12 has a function of transmitting a voice of the vehicle occupant detected via a microphone. Also the on-vehicle unit 10 has a function of outputting, via a speaker, a voice of an operator of the center 14 (who may be referred to as a ‘center operator’, hereinafter) with the use of the portable terminal device 12. Thus, the vehicle occupant and the center operator may verbally communicate with one another via the on-vehicle unit 10 connected with the portable terminal device 12 via the same.

The on-vehicle unit 10 has a help button switch 10b disposed at a position such that the vehicle occupant, in particular, the driver, can operate it, and an airbag unit 10c operating and expanding an airbag 3 for the purpose of protecting the vehicle occupant upon occurrence of a car accident (car crash). The help button switch 10b and the airbag unit 10c are both connected to the master ECU 10a. The master ECU 10a determines whether or not the help button switch 10b has been pressed, and also, determines whether or not the airbag unit 10c has operated and expanded the airbag 3. When the help button 10b switch has been pressed or the airbag 3 has been operated and expanded by the airbag unit 10c, the on-vehicle unit 10 connects with the center 14 via the portable terminal unit 12 for the purpose of notifying the center of this matter together with information identifying the vehicle itself in which the on-vehicle unit 10 is mounted, and generates an urgent message to the center 14.

The on-vehicle unit 10 further has a to-be-controlled ECU group including a plurality of slave ECUs 10d connected with the master ECU 10a via multiplex communication wires. These slave ECUs 10d act as control units controlling the vehicle engine 1; the vehicle brakes 2; a transmission shift position; a vehicle interior environment such as an air conditioner, the oxygen concentration, minus ions and so forth; a camera 5 for photographing vehicle interior; hazard lamps; passing lights; a wireless buzzer and so forth. The master ECU 10a has a function of causing the to-be-controlled ECU group to carry out predetermined processing (specifically, various types of remote control operations), and also, has a function of receiving the remote operation results transmitted from the respective slave ECUs 10d, vehicle data or failure data, if any, accompanying the remote operation results.

As shown in FIG. 5, the center 14 has a computer 14a, acting as an information processing apparatus, and a database 14b having a large storage capacity for storing customer information for each user (car owner or such) who uses the center 14, i.e., identification information, a telephone number of the portable terminal device 12, sex, age, medial history and so forth. The center 14 has a communication unit 14c, and therewith, radio communication with the on-vehicle unit 10 via the communication network 20 is possible. Therewith, from the center 14, own information or a voice of the center operator can be transmitted to the one-vehicle unit 10 via the communication network 20. Further, also with the use of the communication unit 14c, information or a voice transmitted from the on-vehicle unit 10 can be received in the center 14. Further, wireless communication or wired communication is provided with the respective urgent message destinations 16 via the communication network 20. Therewith, from the center 14, own information or a voice of the center operator can be transmitted to the urgent message destination 16 via the communication network 20. Further, also therewith, information or a voice transmitted from the urgent message destination 16 can be received in the center 14.

The center 14 has a display monitor 14d which the operator can see. To this display monitor 14d, the computer 14a, connected to the communication unit 14c, is connected. When information is transmitted from the on-vehicle unit 10 via the communication network 20, the computer 14a of the center 14 reads information for the corresponding user from the customer information stored in the database 14b, and displays the thus-read information and the information transmitted from the on-vehicle unit 10 on the display monitor 14d for the operator. The center 14 transmits an urgent message to the appropriate urgent message destination 16 in response to the operator's manual operation when receiving an urgent message from the on-vehicle unit 10.

In the urgent message system according to the present embodiment, the on-vehicle unit 10 connects to the center 14 for communication with the use of the potable terminal device 12 and transmits an urgent message to the center 14 when determining that the help button switch 10b has been pressed as mentioned above. The help button switch 10b is pressed voluntarily by the vehicle occupant for generating an urgent message, in general. In such a case, it can be determined that the vehicle occupant is in such a condition that he or she can verbally communicate with the operator of the center 14. Then, the center operator can determine that an urgent message should be transmitted to the urgent message destination 16 when a current situation of the vehicle occupant, recognizable from the verbal communication therewith, is an emergent one.

Further, the on-vehicle unit 10 connects to the center 14 via the portable terminal device 12 for communication and transmits an urgent message to the center 14 also when it is determined that the airbag 3 is operated and expanded, as mentioned above. In general, operation and expansion of the airbag 3 is started up automatically by the airbag unit 10c when a car crush occurs and a large shock is applied to the vehicle. In such a case, the center operator can determine, even without verbal communication with the vehicle occupant, that a current situation of the vehicle occupant is an emergent one due to the car crush. As a result, the center operator can determine that an urgent message should be transmitted to the urgent message destination 16.

In these cases, when the urgent message is transmitted to the center 14 from the on-vehicle unit 10 of the vehicle, the operator in the center 14 can properly recognize the situation of the vehicle occupant, and thus, can properly determine whether or not an urgent message should be actually transmitted to the urgent message destination 16. Also, when an urgent message should be transmitted to the urgent message destination 16, the center operator can properly select the appropriate urgent message destination 16. Therefore, when an urgent message is transmitted from the on-vehicle unit 10 to the center 14, the center operator can make an appropriate response.

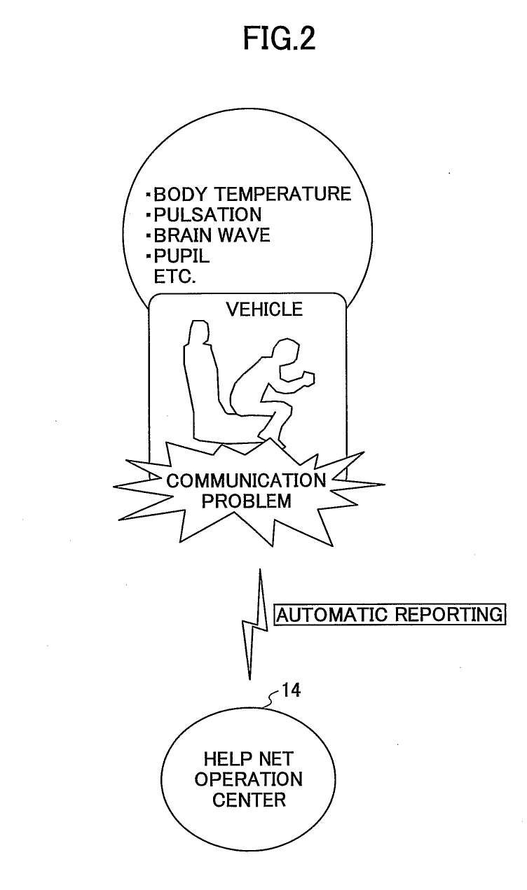

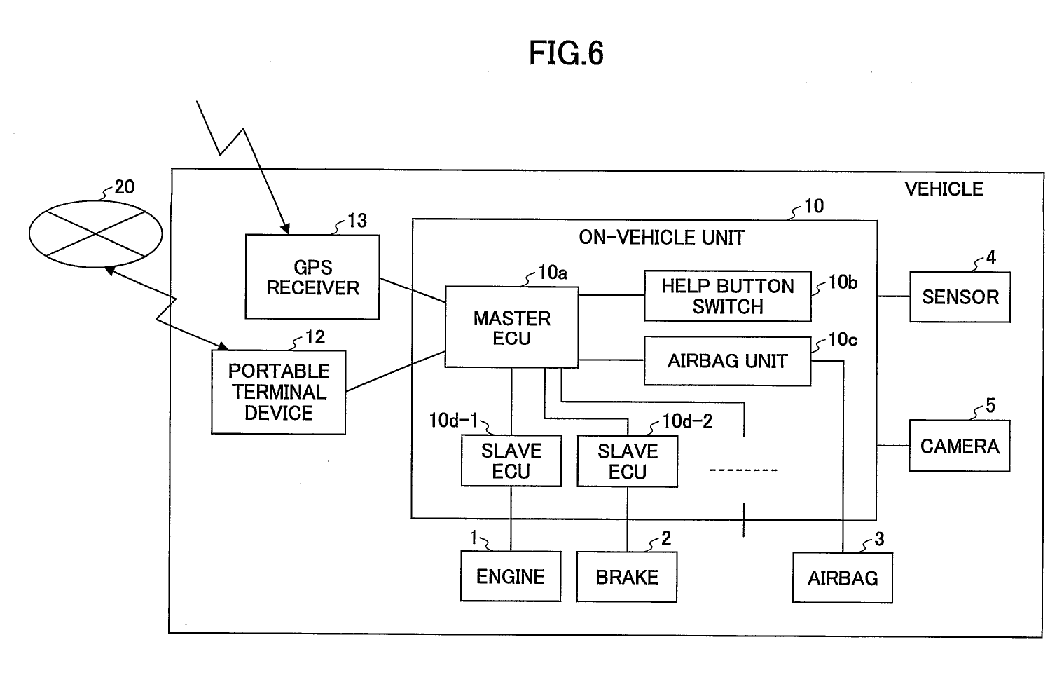

However, when, for example, the vehicle occupant falls in a sudden illness and has a sharp aggravation in his or her physical condition while driving, or the vehicle occupant fights with an intruder, the vehicle occupant may be difficult to press the help button switch 10b by himself or herself. In such a case, generation of an urgent message to the center 14 from the on-vehicle unit 10 may not be achieved until the airbag 3 operates after that for example. The urgent message system according to the present embodiment has features such that, even when the vehicle operator has aggravation in his or her physical condition due to a sudden illness or such, an urgent message can be properly transmitted to the center 14 from the vehicle, and after that, the center 14 can transmit an urgent message to the urgent message destination 16 properly. With reference to FIGS. 2 through 6, these features of the urgent message system according to the present embodiment are described.

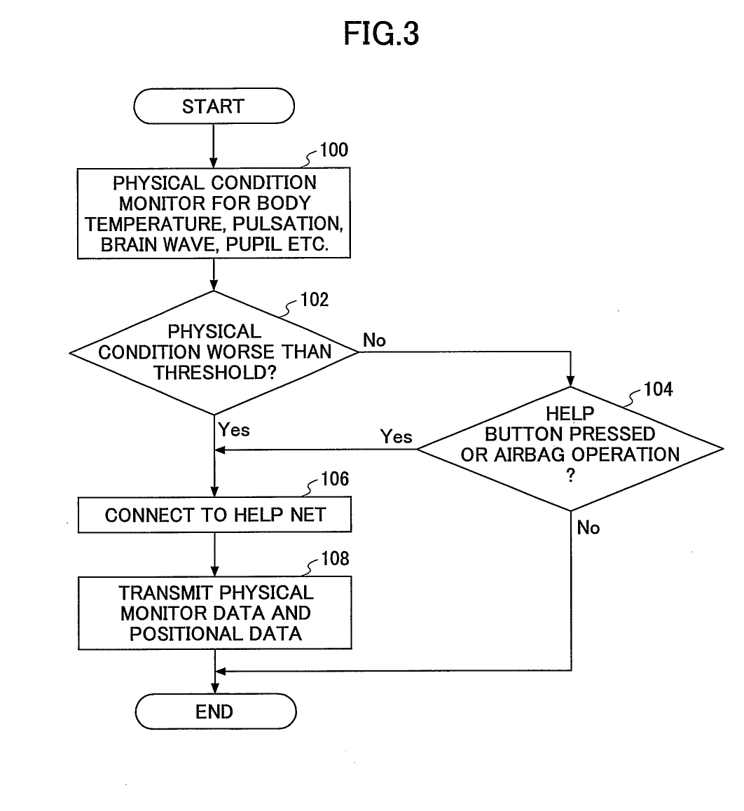

FIG. 2 shows operation of the on-vehicle unit 10 in the urgent message system according to the present embodiment. FIG. 3 shows one example of a flow chart executed by the master ECU 10a of the on-vehicle unit 10. In the present embodiment, the on-vehicle unit 10 detects a physical condition of the vehicle occupant (in particular, the vehicle driver), i.e., the body temperature, blood pressure, pulsation, brain wave, dilation of a pupil, and so forth (Step 100). The thus-obtained physical condition data is simply referred to as ‘monitor data’ or referred to as ‘vehicle occupant's physical condition monitor data’ or ‘physical condition monitor data’, hereinafter. Then, the master ECU 10a determines, from the monitor data, whether or not the vehicle occupant's physical condition deviates from a predetermined normal value, that is, becomes worse than a predetermined threshold (Step 102).

When the on-vehicle unit 10 determines that the vehicle occupant's physical condition does not become worse than the threshold, the on-vehicle unit 10 determines whether or not the help button switch 10b has been pressed or the airbag unit 10c operates (Step 104). As a result, when the determination result is No, the current routine is finished without any further operation. However, when the determination result is Yes, the on-vehicle unit 10 connects to the center 14 for communication with the use of the portable terminal device 12, and transmits an urgent message, including the vehicle positional data and the identification information, to the center 14 (Step 106). On the other hand, when the on-vehicle unit 10 determines that the vehicle occupant's physical condition becomes worse than the threshold (Yes in Step 102), the on-vehicle unit 10 connects to the center 14 for communication with the use of the portable terminal device 12, and transmits an urgent message, including the vehicle positional data and the identification information, to the center 14 (Step 106), whether or not the help button switch 10b has been pressed, or whether or not the airbag unit 10c operates.

When the on-vehicle unit 10 thus transmits the urgent message to the center 14, the on-vehicle unit 10 also transmits, to the center 14, the monitor data concerning the vehicle occupant's physical condition detected in Step 100, together with the own vehicle information at least including the vehicle positional information detected with the use of the GPS receiver 13 and the identification information (Step 108). At this occasion, the on-vehicle unit 10 may further transmit data concerning a range of a normal physical condition of the particular vehicle occupant himself or herself stored in the storage device of the on-vehicle unit 10. Further, the on-vehicle unit 10 may further transmit the vehicle occupant's normal physical condition monitor data detected immediately before the urgent message has been thus transmitted.

As a result, an urgent message can be generated by the on-vehicle unit 10 for the center 14 when the vehicle occupant's physical condition becomes worse, in addition to a case where the help button switch 10a is pressed or the airbag unit 10c operates. Thus, by the urgent message system according to the present embodiment, an urgent message, indicating that the vehicle occupant's physical condition becomes worse, is generated from the on-vehicle unit 10 to the center 14 automatically even when the help button switch 10a is not pressed because the vehicle occupant's physical condition becomes worse as mentioned above. Thus, the operator in the center 14 can recognize that the vehicle occupant's physical condition becomes worse.

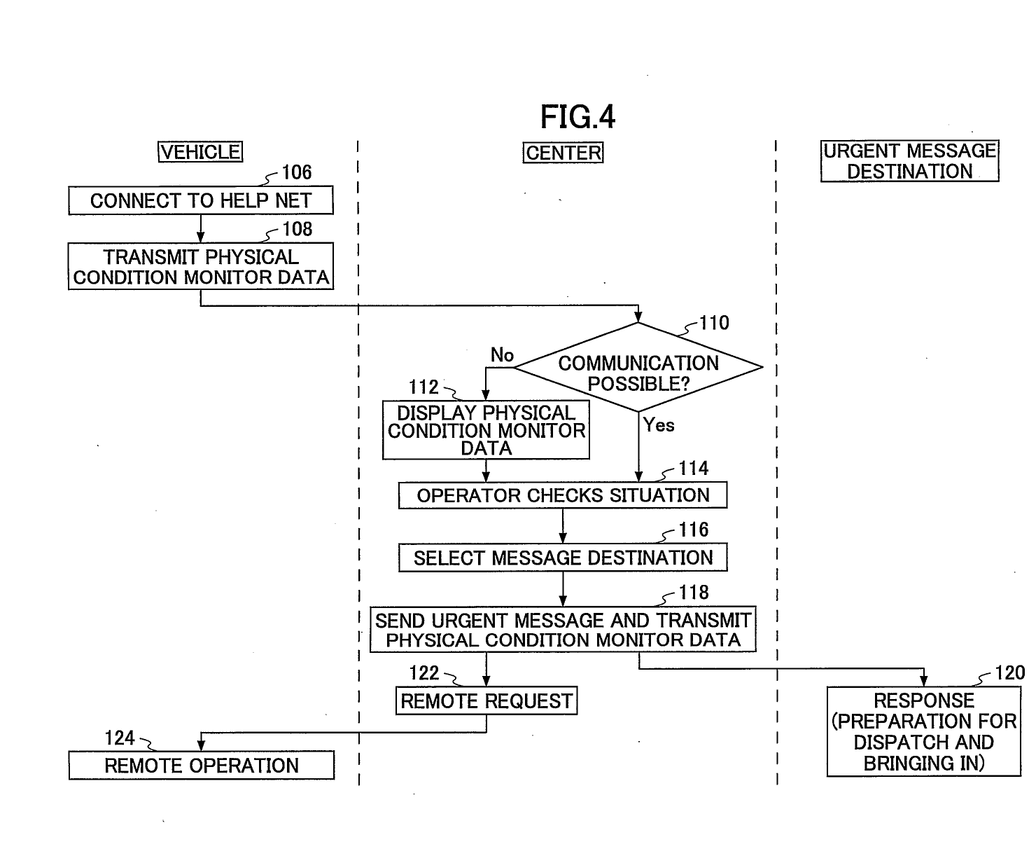

FIG. 4 shows a flow chart executed by the urgent message system in the present embodiment. In the urgent message system, when the vehicle occupant's physical condition monitor data is transmitted from the on-vehicle unit 10 to the center 14, this data is stored in a memory of the computer 14a in the center 14. After the transmission is completed, verbal communication can be made possible between the on-vehicle unit 10 and the center 14.

The operator in the center 14 can recognize a current situation of the vehicle occupant from a voice explanation or a tone of the voice obtained via the on-vehicle unit 10 (Step 114) when verbal communication with the vehicle occupant is possible (Yes in Step 110). Then, the centre operator 14 determines, from the thus-recognized situation of the vehicle occupant, whether or not an urgent message should be actually transmitted to the urgent message destination 16 from the center 41. When an urgent message should be actually transmitted to the urgent message destination 16, the center operator selects the urgent message destination 16 from a determination as to whether or not the police, fire fighting, JAF or such should be called out, whether or not the vehicle occupant should be brought into a hospital, for example (Step 116).

On the other hand, when the center operator determines that verbal communication with the vehicle occupant cannot be possible since the vehicle occupant's voice cannot be heard (No in Step 110), the center operator operates the computer 14a to cause it to display, on the display monitor 14d, the vehicle occupant's physical condition monitor data and, if necessary, the normal value range data therefor, transmitted from the on-vehicle unit 10 via the communication unit 14c (Step 112). To display the vehicle occupant's physical condition monitor data and so forth on the display monitor 14d may be made, whether or not verbal communication between the vehicle occupant and the center operator is possible.

As a result of the vehicle occupant's physical condition monitor data being thus displayed, the center operator can recognize, even when the vehicle occupant's voice cannot be actually heard, the vehicle occupant's current physical condition, for example, an excited condition, body temperature rise, blood pressure drop, pulsation weakness, chronic disease onset, or such, from the physical condition monitor data thus displayed on the display monitor 14d (Step 114). Then, the center operator determines, from the thus-recognized situation, whether or not an urgent message to the urgent message destination 16 from the center 14 is actually needed. Then, when the urgent message to the urgent message destination 16 is actually needed, the center operator selects the urgent message destination 16 from a determination as to whether or not the police, fire fighting (fire station), JAF or such should be called out, whether or not the vehicle occupant should be brought into a hospital, for example (Step 116). For example, when the center operator determines that the vehicle occupant is in an excited condign such as a blood pressure rise, pulsation abnormality or such, the vehicle occupant may have been attacked by an intruder. Therefore, the center operator selects the police as the urgent message destination 16 in this case. On the other hand, when the center operator determines that the vehicle occupant falls in a sudden illness, such as a blood pressure drop, pulsation weakness, chronic disease onset, or such, the center operator selects the fire fighting as the urgent message destination 16, from which an ambulance is called out.

When the operator thus selects the urgent message destination 16 and operates the computer 14a of the center 14 for transmitting an urgent message to the thus-selected urgent message destination 16, the computer 14a transmits, via the communication unit 14c, the urgent message, together with the vehicle positional data and the identification information, to the urgent message destination 16. Also, the computer 14a of the center 14 transfers, via the communication unit 14c, the vehicle occupant's physical condition monitor data, transmitted from the on-vehicle unit 10, to the urgent message destination 16 when calling out of an ambulance from a fire station as the urgent message destination 16 and asking the fire station to bring the vehicle occupant into a hospital (Step 118).

When receiving the urgent message from the center 14, the urgent message destination 16 dispatches a police car to the vehicle location identified from the vehicle positional information if the urgent message destination 16 is the police. If the urgent message destination 16 is a fire station, the urgent message destination 16 dispatches an ambulance with appropriate equipment for the vehicle occupant's physical condition to the vehicle location identified from the vehicle positional data. If the urgent message destination 16 is a hospital, the hospital prepares for bringing the vehicle occupant therein (Step 120).

In this embodiment, the center operator can see, with his or her eyes, the physical condition monitor data, transmitted from the on-vehicle unit 10, on the display monitor 14d of the center 14 as mentioned above. At this time, the center operator determines the physical condition (for example, an excited condition, body temperature rise, blood pressure drop, pulsation weakness, chronic disease onset, or such) of the vehicle occupant by comparing the physical condition monitor data thus displayed on the display monitor 14d with a normal value range (a general value range or a special one which is unique to each particular vehicle occupant) previously stored in the database 14b of the center 14. As a result, the center operator can determine whether or not an urgent message should be actually transmitted to the urgent message destination 16, and select the urgent message destination 16.

Thus, in the urgent message system in the present embodiment, the center operator can determine whether or not an urgent massage should be actually transmitted to the urgent message destination 16 even when the center operator cannot make verbal communication with the vehicle occupant due to the vehicle occupant's physical condition problem after an urgent message from the on-vehicle unit 10 is received by the center 14. As a result, an urgent message can be transmitted to the urgent message destination 16 from the center 14 properly according to the vehicle occupant's physical condition, and also, an appropriate organization can be set as the urgent message destination 16 appropriately selected when the urgent message is required thereto. As a result, proper urgent message transmission determination can be achieved. Thus, the center 14 can take optimum measures in response to an urgent message from the on-vehicle unit 10.

Further, in the above-described processing, the vehicle occupant's physical condition monitor data is transferred if necessary to the urgent message destination 16 when an urgent message is transmitted to the urgent message destination 16 from the center 14, as mentioned above. When the vehicle occupant's physical condition monitor data is thus provided to the urgent message destination 16, the urgent massage destination 16 can recognize the vehicle occupant's physical condition. Therefore, in the urgent message system according to the present embodiment, the urgent message destination 16 can carry out appropriate preparation according to the particular vehicle occupant's physical condition when the urgent message is transmitted to the urgent message destination 16. As a result, the urgent message destination 16 can take appropriate measures rapidly for the vehicle occupant's physical condition problem.

Further, when the operator of the center 14 determines that optimization of the vehicle interior environment appropriate for the vehicle occupant's physical condition is needed, especially under a state in which the center operator cannot make a verbal communication with the vehicle occupant, the center operator operates the computer 14a to transmit a signal requesting the on-vehicle unit 10 for remotely operating respective ones of vehicle interior equipment (Step 122) at the same time when or after an urgent message is transmitted to the urgent message destination 16 in response to an urgent message received from the on-vehicle unit 10. The on-vehicle unit 10 responds to the request from the center 14 for remotely operating the vehicle interior equipment received from the center 14 after transmitting the urgent message to the center 14, and carries out corresponding remote operation of the vehicle interior equipment (Step 124).

As the actual remote operation in the vehicle, for example, cooling or heating the vehicle interior with the use of a vehicle interior air conditioner, enrichment and increase a concentration of the vehicle interior oxygen, generation of minus ions for the purpose of improving the vehicle interior environment; turning on or blinking the hazard lamps or the passing lights, blowing a wireless buzzer or such for indicating the vehicle location or alarming to the surroundings; and further, reducing the engine revolution speed, applying the brakes or shifting down the transmission for ensuring the safety of the vehicle, or such, may be carried out.

In this configuration, even if the vehicle occupant falls into a sudden illness and thus cannot properly operate the vehicle or cannot show this situation to the surroundings, an urgent message is automatically transmitted to the center 14, the center 14 responds thereto to transmit an urgent message to the urgent message destination 16, and further, instructions are given, instead of manual operation of the vehicle occupant, to the on-vehicle unit 10 from the center 14, and thereby, the vehicle interior air conditioner and so forth can be controlled, an alarm can be generated to the outside of the vehicle, and/or the vehicle running can be controlled, automatically.

As a result, according to the urgent message system according to the present embodiment, the vehicle interior environment can be improved appropriately for easing the vehicle occupant's physical condition problem without requiring any operation by the vehicle occupant himself or herself, who has the physical condition problem. As a result, the vehicle occupant's physical condition can be prevented from being further aggravated, and also, a pain of the vehicle occupant can be eased. Further, the hazard lamp blinking, the passing light turning on, the wireless buzzer blowing and so forth are carried out for alarming to the vehicle surroundings without requiring any operation by the vehicle occupant, who has the physical condition problem. As a result, a safety of the vehicle surroundings can be urged, after the vehicle occupant's physical condition problem has occurred, and also, a police car or an ambulance called out in response to the urgent message can easily find out the corresponding vehicle on which the occupant having the physical condition problem rides. Further, the vehicle can be automatically reduce its driving speed, or brought into a stop as mentioned above without requiring any operation by the vehicle occupant, who has the physical condition problem. As a result, a safety of the vehicle surroundings can be urged, after the vehicle occupant's physical condition problem has occurred, and also, a contingency can be prevented from occurring, to the minimum possible.

The above-mentioned various types of sensors 4 or the camera 5, act as a physical condition monitoring part, for the on-vehicle unit 10 to detect the vehicle occupant's physical condition.

In the above-described embodiment, when an urgent message is transmitted to the center 14 from the on-vehicle unit 10, the vehicle occupant's physical condition monitor data thus detected by the on-vehicle unit 10 is transmitted to the center 14 from the on-vehicle unit 10, and also, the data is displayed on the display monitor 14d in the center 14 for the operator. Further, photo data taken by the camera 5 provided to take a photo of the vehicle interior may also be transmitted to the center 14 from the on-vehicle unit 10, and also, the photo data may be displayed on the display monitor 14d in the center 14 for the operator. Thereby, the center operator can recognize not only the vehicle interior situation but also the vehicle occupant's physical condition by seeing an image thus displayed on the display monitor 14d. As a result, the center operator can determine, with a higher accuracy, whether or not an urgent message should be actually transmitted to the urgent message destination 16 for the vehicle occupant, and select the urgent message destination 16. Accordingly, even when the centre operator cannot make a verbal communication with the vehicle occupant after receiving an urgent message from the on-vehicle unit 10, the center operator can appropriately determine whether or not an urgent message should be actually transmitted to the urgent message destination 16 based on the image displayed on the display monitor 14d. As a result, an urgent message can be appropriately transmitted to the urgent message destination 16 from the center 14 even when the vehicle occupant has a physical condition problem, for example.

On this occasion, photo data taken by the camera 5 may be transmitted at any time when an urgent message is transmitted from the on-vehicle unit 10 to the center 14. Instead, the same may be transmitted to the center 14 only when the transmission is requested by the center 14 after the urgent message is transmitted from the on-vehicle unit 10 to the center 14. Photo data taken by the camera 5 thus transmitted to the center 14 from the on-vehicle unit 10 may be one taken at the time the urgent message is thus transmitted. Instead, the same may include one taken immediately before the transmission of the urgent message. Further, photo data taken by the camera 5 thus transmitted to the center 14 from the on-vehicle unit 10 may be one taken at the urgent message is thus transmitted. Instead, the same may one taken in response to a request for the remote operation transmitted from the center 14.

Further, in the present embodiment described above, the vehicle interior equipment is remotely operated in response to a vehicle interior equipment remote operation request transmitted from the center 14 to the on-vehicle unit 10 when the center 14 transmits an urgent message to the urgent message destination 16. In this occasion, a remote operation for improving the vehicle interior environment such as air conditioning; a remote operation for alarming to the vehicle surroundings such as hazard lamp turning on or such; and a remote operation for ensuring the vehicle safety such as engine revolution speed reduction or such, may be requested from the center 14 to the on-vehicle unit 10 separately, or, may be requested together in a lump.

Further, in the present embodiment described above, the vehicle occupant's physical condition monitor data is displayed on the display monitor 14d for the center operator to appropriately determine whether or not transmission of an urgent message should be actually made to the urgent message destination 16 from the center 14. In this occasion, the computer 14a of the center 14 may have a map indicating whether or not the vehicle occupant's physical condition deviates from a normal value range, i.e., whether or not the vehicle occupant's physical condition becomes so bad that an urgent message should be transmitted to the urgent message destination 16. Then, the physical condition monitor data transmitted from the on-vehicle unit 10 may be compared by the computer 14a with this map, and the computer 14a may determine, therefrom, whether or not an urgent message should be actually transmitted from the center 14 to the urgent message destination 16. The map, the computer 14a of the center 14 has or stores, should be different for respective ones of the urgent message destinations 16 to which urgent messages are to be transmitted, and the computer 14a of the center 14 should determine, for each particular urgent message destination 16, whether or not an urgent message should be transmitted.

In this configuration, an urgent message is automatically transmitted to the appropriate urgent message destination 16 when an urgent message is automatically transmitted from the on-vehicle unit 10 to the center 14 due to the vehicle occupant's physical condition aggravation, and also, the center determines that the vehicle occupant's physical condition deviates from the normal value range based on the physical condition monitor data transmitted from the on-vehicle unit 10 with the use of the map at this occasion. Accordingly, even when the center operator cannot make a verbal communication with the vehicle occupant due the vehicle occupant's physical condition aggravation, an urgent message is automatically transmitted from the center 14 to the urgent massage destination 16 according to the vehicle occupant's physical condition. As a result, an urgent message can be appropriately transmitted to the urgent message destination 16 from the center 14 even when the vehicle occupant has a physical condition problem, for example.

Also in this case in which the computer 14a of the center 14 automatically determines whether or not an urgent message should be actually transmitted to the urgent message destination 16, a configuration may be provided whereby, the computer 14a of the center 14 analyzes photo data, taken by the camera 5 provided to take a photo of the vehicle interior, and transmitted from the on-vehicle unit 10 to the center 14, and automatically determines, from the analysis result, whether or not an urgent message should be actually transmitted to the urgent message destination 16. In this configuration, even when the center operator cannot make a verbal communication with the vehicle occupant due the vehicle occupant's physical condition aggravation, and cannot determine, only from the physical condition monitor data transmitted from the on-vehicle unit 10, whether or not an urgent message should be actually transmitted to the urgent message destination 16, an urgent message is automatically transmitted from the center 14 according to the vehicle interior situation based on the photo data. Accordingly, an urgent message can be appropriately transmitted to the urgent message destination 16 from the center 14 even when the vehicle occupant has a physical condition problem, for example.

In the above-described embodiment, vehicle occupant's physical condition monitor data may be transmitted to the urgent message destination 16 together with an urgent message when the computer 14a in the center 14 determines that the urgent message should be actually transmitted to the urgent message destination 16. On this occasion, also the vehicle occupant's data, such as a name, age, sex, medical history, contact address, and so forth, stored in the database 14b of the center 14, should be preferably transmitted together so that the urgent message destination 16 may take appropriate measures accordingly.

In this case, the vehicle occupant's physical condition monitor data is transmitted to the urgent message destination 16 from the on-vehicle unit 10 via the center 14. On this occasion, the on-vehicle unit 10 may determine whether or not the vehicle door is left open after transmitting an urgent message to the center 14. Then, when the on-vehicle unit 10 determines that the vehicle door is left open, the on-vehicle unit 10 may verbally announce or display on a monitor, the vehicle occupant's physical condition, transmitted to the center 14 or currently detected. In this configuration, the vehicle occupant's situation can be easily and rapidly shown to a third person who by accident exists in the vehicle surroundings, policemen or ambulance crews, who come there when a police car or an ambulance reaches there in response to the urgent message. As a result, these persons can take rapid measures accordingly.

In this configuration where the vehicle occupant's physical condition is shown to the surroundings of the vehicle when the on-vehicle unit 10 determines that the vehicle door is left open, the on-vehicle unit 10 may also make a voice output or such of the vehicle occupant's medical history in addition to the vehicle occupant's physical condition when the vehicle door is left open. Instead, only a fact that a physical condition problem has occurred, may be shown by a voice output or such on this occasion.

Further, the on-vehicle unit 10 may make a voice output or such to show, not only the vehicle occupant's physical condition but also the vehicle occupant's name, age, sex, medical history, contact address and so forth.

Further, in the above-described embodiment, the on-vehicle unit 10 transmits an urgent message to the center 14 at any time a vehicle occupant has a physical condition problem, without regard to a specific one of the urgent message destinations 16 actually selected in this case. However, instead, an urgent message may be transmitted to the center 14 only when a predetermined type of a physical condition problem occurs, the type of physical condition problem being previously registered by the vehicle occupant by his or her switch operation or such. And then, an urgent massage may be allowed to be transmitted only to a corresponding specific urgent message destination 16.

Further, the present invention is not limited to the above-described embodiment, and variations and modifications may be made without departing from the basic concept of the present invention claimed below.

The present application is based on Japanese priority application No. 2005-004371, filed on Jan. 11, 2005, the entire contents of which are hereby incorporated herein by reference.

1. An information processing apparatus, receiving an urgent message from a vehicle, and, transmitting an urgent message to a predetermined urgent message destination if necessary, comprising:
a receiving part receiving vehicle occupant's physical condition information from the vehicle when receiving the urgent massage from the vehicle, said vehicle occupant's physical condition information being one obtained from a physical condition monitoring part provided in the vehicle for detecting a physical condition of a vehicle occupant; and
a determining part determining whether or not an urgent message is to be transmitted to the predetermined urgent message destination, based on the received vehicle occupant's physical condition.

2. The information processing apparatus as claimed in claim 1, wherein:
said receiving part receives vehicle interior image information taken by a camera provided in the vehicle to take a vehicle interior situation, together with the urgent message from the vehicle; and
said determining part determines whether or not an urgent message is to be transmitted to the predetermined urgent message destination, based on the vehicle interior image information thus received.

3. The information processing apparatus as claimed in claim 1, further comprising:
a selecting part selecting the predetermined urgent message destination based on the vehicle occupant's physical condition information or the vehicle interior image information, received from the vehicle.

4. An information processing apparatus, receiving an urgent message from a vehicle, and, transmitting an urgent message to a predetermined urgent message destination if necessary, comprising:
a receiving part receiving vehicle occupant's physical condition information from the vehicle when receiving the urgent massage from the vehicle, said vehicle occupant's physical condition information being one obtained from a physical condition monitoring part provided in the vehicle for detecting a physical condition of a vehicle occupant;
a showing part showing an operator the received vehicle occupant's physical condition for the purpose of allowing the operator to determine whether or not an urgent message is to be transmitted to the predetermined urgent message destination.

5. The information processing apparatus as claimed in claim 4, wherein:
said receiving part receives vehicle interior image information taken by a camera provided in the vehicle to take a vehicle interior situation, together with the urgent message from the vehicle; and
said showing part shows the operator the received vehicle interior image information for the purpose of allowing the operator to determine whether or not an urgent message is to be transmitted to the predetermined urgent message destination.

6. The information processing apparatus as claimed in claim 1, further comprising:
a transferring part transferring, upon transmitting an urgent message to the predetermined urgent message destination, the vehicle occupant's physical condition information received from the vehicle to the predetermined urgent message destination.

7. The information processing apparatus as claimed in claim 4, further comprising:
a transferring part transferring, upon transmitting an urgent message to the predetermined urgent message destination, the vehicle occupant's physical condition information received from the vehicle to the predetermined urgent message destination.

8. The information processing apparatus as claimed in claim 1, further comprising:
a requesting part requesting the vehicle to carry out a vehicle interior environment remote operation for improving a vehicle interior environment, when receiving the vehicle occupant's physical information from the vehicle.

9. The information processing apparatus as claimed in claim 4, further comprising:
a requesting part requesting the vehicle to carry out a vehicle interior environment remote operation for improving a vehicle interior environment, when receiving the vehicle occupant's physical information from the vehicle.

10. The information processing apparatus as claimed in claim 1, further comprising:
a requesting part requesting the vehicle to carry out an attention attracting remote operation for attracting an attention from the vehicle surroundings, when receiving the vehicle occupant's physical information from the vehicle.

11. The information processing apparatus as claimed in claim 4, further comprising:
a requesting part requesting the vehicle to carry out an attention attracting remote operation for attracting an attention from the vehicle surroundings, when receiving the vehicle occupant's physical information from the vehicle.

12. The information processing apparatus as claimed in claim 1, further comprising:
a requesting part requesting the vehicle to carry out a running remote operation for bringing the vehicle into a stop or reducing the speed, when receiving the vehicle occupant's physical information from the vehicle.

13. The information processing apparatus as claimed in claim 4, further comprising:
a requesting part requesting the vehicle to carry out a running remote operation for bringing the vehicle into a stop or reducing the speed, when receiving the vehicle occupant's physical information from the vehicle.

14. A vehicle control system, comprising:
a physical condition monitoring part monitoring a physical condition of a vehicle occupant; and
a transmitting part transmitting, upon transmitting an urgent message to a center, the vehicle occupant's physical condition information detected by said physical condition monitoring part to the center.

15. The vehicle control system as claimed in claim 14, wherein:
said transmitting part transmits vehicle interior image information taken by a camera provided in the vehicle for taking a situation in the vehicle interior, to the center when transmitting the urgent message to the center.

16. The vehicle control system as claimed in claim 14, further comprising:
a remote operation carrying out part responding to a request from the center to carry out a vehicle interior environment remote operation for improving a vehicle interior environment, to carry out the vehicle interior enlivenment remote operation.

17. The vehicle control system as claimed in claim 14, further comprising:
a remote operation carrying out part responding to a request from the center to carry out an attention attracting remote operation for attracting an attention from the vehicle surroundings, to carry out the attention attracting remote operation.

18. The vehicle control system as claimed in claim 14, further comprising:
a remote operation carrying out part responding to a request from the center to carry out a running remote operation for bringing the vehicle into a stop or reducing the speed, to carry out the running remote operation.

19. The vehicle control system as claimed in claim 14, wherein:
said transmitting part transmits an urgent message to the center when the vehicle occupant's physical condition detected by the physical condition motoring part deviates from a normal value.

20. An information processing method of transmitting an urgent message to a predetermined urgent message destination from a center if necessary when receiving an urgent message from a vehicle, comprising:
a physical condition monitoring step of monitoring a physical condition of a vehicle occupant;
a transmitting step of transmitting the vehicle occupant's physical condition information to the center from the vehicle when an urgent message is transmitted to the center; and
a determining step of determining in the center whether or not an urgent message is to be transmitted to the predetermined urgent message destination, based on the vehicle occupant's physical condition information transmitted from the vehicle.

21. The information processing method as claimed in claim 20, wherein:
in said transmitting step, vehicle interior image information taken by a camera provided for taking a situation of the vehicle interior is transmitted to the center from the vehicle when an urgent message is transmitted to the center; and
in said determining step, the center determines whether or not an urgent message is to be transmitted to the predetermined urgent message destination, based on the vehicle interior image information transmitted from the vehicle.

22. The information processing method as claimed in claim 20, further comprising:
a selecting step of selecting in the center the predetermined urgent message destination based on the vehicle occupant's physical condition information or the vehicle interior image information transmitted from the vehicle.

23. An information processing method of transmitting an urgent message to a predetermined urgent message destination from a center if necessary when receiving an urgent message from a vehicle, comprising:
a physical condition monitoring step of monitoring a physical condition of a vehicle occupant;
a transmitting step of transmitting the vehicle occupant's physical condition information to the center from the vehicle when an urgent message is transmitted to the center; and
a showing step of showing in the center an operator the vehicle occupant's physical condition information transmitted by the vehicle for allowing the operator to determine whether or not an urgent message is to be transmitted to the predetermined urgent message destination.

24. The information processing method as claimed in claim 23, wherein:
in said transmitting step, vehicle interior image information taken by a camera provided for taking a situation of the vehicle interior is transmitted to the center from the vehicle when an urgent message is transmitted to the center; and
in said determining step, the center shows an operator the vehicle interior image information transmitted from the vehicle for allowing the operator to determine whether or not an urgent message is to be transmitted to the predetermined urgent message destination.

25. The information processing method as claimed in claim 23, further comprising:
a transferring step of transferring from the center, upon transmitting an urgent message to the predetermined urgent message destination, the vehicle occupant's physical condition information received from the vehicle to the predetermined urgent message destination.

26. The information processing method as claimed in claim 20, further comprising:
a requesting step of requesting, from the center, the vehicle to carry out a vehicle interior environment remote operation for improving a vehicle interior environment, when the center receives the vehicle occupant's physical information from the vehicle; and
a carrying out step of carrying out, in the vehicle, the vehicle interior environment remote operation according to the request from the center.

27. The information processing method as claimed in claim 20, further comprising:
a requesting step of requesting, from the center, the vehicle to carry out an attention attracting remote operation for attracting an attention from the vehicle surroundings, when the center receives the vehicle occupant's physical information from the vehicle; and
a carrying out step of carrying out, in the vehicle, the attention attracting remote operation according to the request from the center.

28. The information processing method as claimed in claim 20, further comprising:
a requesting step of requesting, from the center, the vehicle to carry out a running remote operation for bringing the vehicle into a stop or reducing the speed, when the center receives the vehicle occupant's physical information from the vehicle; and
a carrying out step of carrying out, in the vehicle, the running remote operation according to the request from the center.

29. The information processing method as claimed in claim 20, wherein:
in said transmitting step, the vehicle transmits an urgent message to the center when the vehicle occupant's physical condition detected in the physical condition motoring step deviates from a normal value.

30. The information processing method as claimed in claim 23, wherein:
in said transmitting step, the vehicle transmits an urgent message to the center when the vehicle occupant's physical condition detected in the physical condition motoring step deviates from a normal value.
